(19) United States
(12) Patent Application Publication
(10) Pub. No.: US 2026/0333317 A1
(43) Pub. Date: Oct. 22, 2026

(54) SYSTEMS AND METHOD FOR WI-FI/NARROWBAND (NB) COEXISTENCE (COEX) ACTIVITY INDICATION FOR PARTIAL BANDWIDTHS

(71) Applicant: Meta Platforms Technologies, LLC, Menlo Park, CA (US)

(72) Inventors: Muhammad Kumail HAIDER, Sunnyvale, CA (US); Guoqing LI, Cupertino, CA (US); Carlos Horacio ALDANA, Mountain View, CA (US)

(73) Assignee: Meta Platforms Technologies, LLC, Menlo Park, CA (US)

(21) Appl. No.: 19/648,726

(22) Filed: Apr. 15, 2026

Related U.S. Application Data
(60) Provisional application No. 63/790,716, filed on Apr. 18, 2025.

(51) Int. Cl. H04W 72/0446

(52) U.S. Cl. CPC H04W 72/0446

(57) ABSTRACT

A device may include one or processors. The one or more processors may generate a first frame including a first indication to an access point (AP) that the device has a probability of being unavailable, rather than being completely unavailable, during a particular time interval. The one or more processors may wirelessly transmit, via a transceiver to the AP in a wireless local area network, the first frame.

### CROSS-REFERENCE TO RELATED APPLICATION

This application claims priority to U.S. Provisional Patent Application No. 63/790,716 filed on Apr. 18, 2025, which is incorporated by reference herein in its entirety for all purposes.

### FIELD OF DISCLOSURE

The present disclosure is generally related to communications, including but not limited systems and methods of indicating a soft unavailability of a device, where the device may have some probability of being unavailable during indicated time and/or with respect to indicated frequency resources .

### BACKGROUND

Artificial reality, such as virtual reality (VR), augmented reality (AR), or mixed reality (MR), provides immersive experience to a user. In one example, a user wearing a head wearable display (HWD) can turn the user’s head to one side, and an image of a virtual object corresponding to a location and/or an orientation of the HWD and a gaze direction of the user can be displayed on the HWD to allow the user to feel as if the user is moving within a space of an artificial reality (e.g., a VR space, an AR space, or a MR space). An image of a virtual object may be generated by a computing device communicatively coupled to the HWD. In some embodiments, the computing device may have access to a network.

### SUMMARY

Various embodiments disclosed herein are related to a device including one or more processors. The one or more processors may generate a first frame including a first indication to an access point (AP) that the device has a probability of being unavailable, rather than being completely unavailable, during a particular time interval. The one or more processors may wirelessly transmit, via a transceiver to the AP in a wireless local area network, the first frame.

Various embodiments disclosed herein are related to a method. The method may include generating, by a device, a first frame including a first indication to an access point (AP) that the device has a probability of being unavailable, rather than being completely unavailable, during a particular time interval. The method may include wirelessly transmitting, by the device to the AP in a wireless local area network, the first frame.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing target wake time (TWT), according to an example implementation of the present disclosure.

FIG. 5 is a diagram showing an example coexistence activity in an operating bandwidth, according to an example implementation of the present disclosure.

FIG. 6A and FIG. 6B illustrate example field formats for indicating soft unavailability and/or coexistence activities during indicated time and/or with respect to indicated frequency resources , according to an example implementation of the present disclosure.

FIG. 7A illustrates example field formats for indicating soft unavailability and/or coexistence activities during indicated time and/or with respect to indicated frequency resources , according to an example implementation of the present disclosure.

FIG. 7B illustrates a table showing a plurality of bits representing corresponding subchannels of a basic service set bandwidth, according to an example implementation of the present disclosure.

FIG. 8 is a flowchart showing a method for indicating soft unavailability and/or coexistence activities during indicated time and/or with respect to indicated frequency resources , according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Streams of traffic may be characterized by different types of traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60Hz, 72Hz, 90Hz, or 120Hz. An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics.

TWT can be a time agreed/negotiated upon by devices (e.g., access points (APs) and/or stations (STAs)), or specified/configured by one device (e.g., an AP). During the wake time, a first device (e.g., a STA) may be in an awake state (e.g., its wireless communication module/interface is in a fully powered-up ready, or wake state) and is able to transmit and/or receive. When the first device is not awake (e.g., its wireless communication module/interface is in a powered-down, low power, or sleep state), the first device may enter a low power mode or other sleep mode. The first device may exist in the sleep state until a time instance/window as specified by the TWT.

TWT is a mechanism where a set of service periods (SPs) are defined and shared between devices to reduce medium contention and improve the power efficiency of the devices. For example, the first device can wake up periodically (e.g., at a fixed, configured time interval/period/cycle) based on the TWT. The TWT reduces energy consumption of the devices by limiting the awake time and associated power consumption of the devices.

An AP (e.g., AP and/or other device operating as a soft AP/hotspot) may enhance medium access protection and resource reservation by supporting restricted TWT (R-TWT). The R-TWT SPs may be used to deliver latency sensitive traffic and/or any additional frame that supports latency sensitive traffic.

Latency sensitive traffic that is not prioritized (or protected) may degrade a user experience. For example, in an AR context, latency between a movement of a user wearing an AR device and an image corresponding to the user movement and displayed to the user using the AR device may cause judder, resulting in motion sickness.

In one implementation, an image of a virtual object is generated by a remote computing device communicatively coupled to the HWD, and the image is rendered by the HWD to conserve computational resources and/or achieve bandwidth efficiency. In one example, the HWD includes various sensors that detect a location and/or orientation of the HWD and a gaze direction of the user wearing the HWD, and transmits sensor measurements indicating the detected location and gaze direction to a console device (and/or a remote server, e.g., in the cloud) through a wired connection or a wireless connection. The console device can determine a user’s view of the space of the artificial reality according to the sensor measurements, and generate an image of the space of the artificial reality corresponding to the user’s view. The console device can transmit the generated image to the HWD, by which the image of the space of the artificial reality corresponding to the user’s view can be presented to the user. In one aspect, the process of detecting the location of the HWD and the gaze direction of the user wearing the HWD, and rendering the image to the user should be performed within a frame time (e.g., less than 11 ms). Any latency between a movement of the user wearing the HWD and an image displayed corresponding to the user movement can cause judder, which may result in motion sickness and can degrade the user experience.

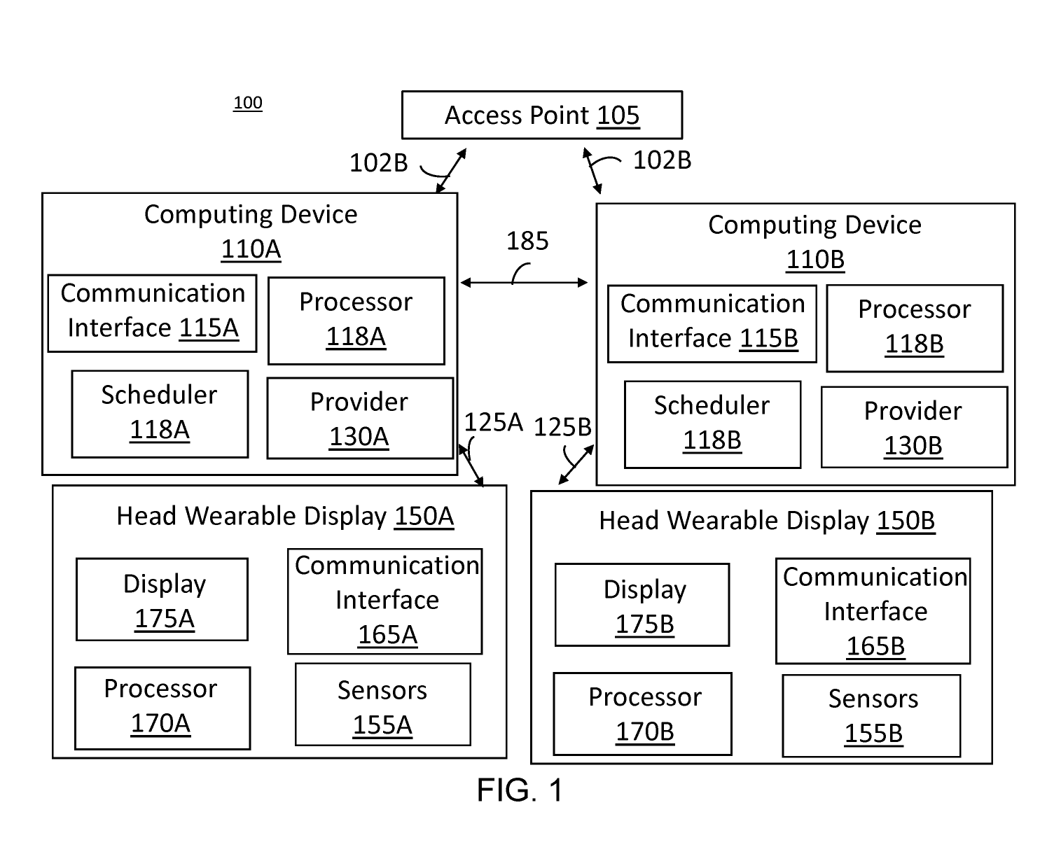

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user’s view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is -10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155.In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10 %) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user’s eyes. In one aspect, the electronic display 175 emits or projects light towards the user’s eyes according to image generated by the processor 170 (e.g., image renderer).

In some embodiments, the HWD 150 may include a lens to allow the user to see the display 175 in close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality . In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 can map the location of the HWD 150 in a physical space to a location within an artificial reality space, and can determine a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and may transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request R-TWT to transmit latency sensitive traffic using P2P (peer-to-peer) communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110wish to schedule P2P communication in R-TWT service periods (SPs). The scheduler 118 of the computing device(s) may schedule (or negotiate) the requested R-TWT SP(s). The scheduler 118 of the computing device(s) may also indicate if the SP(s) are requested only for P2P communication (as compared to mixed P2P communication and non-P2P communication).

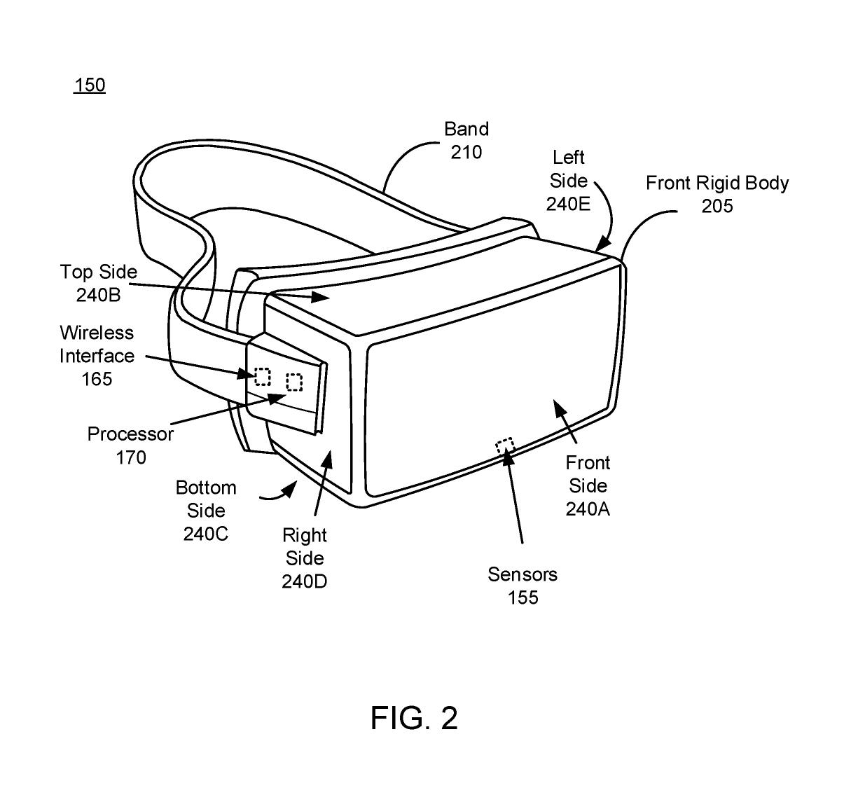

FIG. 2 is a diagram of a HWD 150, in accordance with an example embodiment. In some embodiments, the HWD 150 includes a front rigid body 205 and a band 210. The front rigid body 205 can include the electronic display 175 (not shown in FIG. 2), the lens (not shown in FIG. 2), the sensors 155, the eye trackers the communication interface 165, and/or the processor 170. In the embodiment shown by FIG. 2, the sensors 155 are located within the front rigid body 205, and may not visible to the user. In other embodiments, the HWD 150 has a different configuration than shown in FIG. 2. For example, the processor 170, the eye trackers, and/or the sensors 155 may be in different locations than shown in FIG. 2.

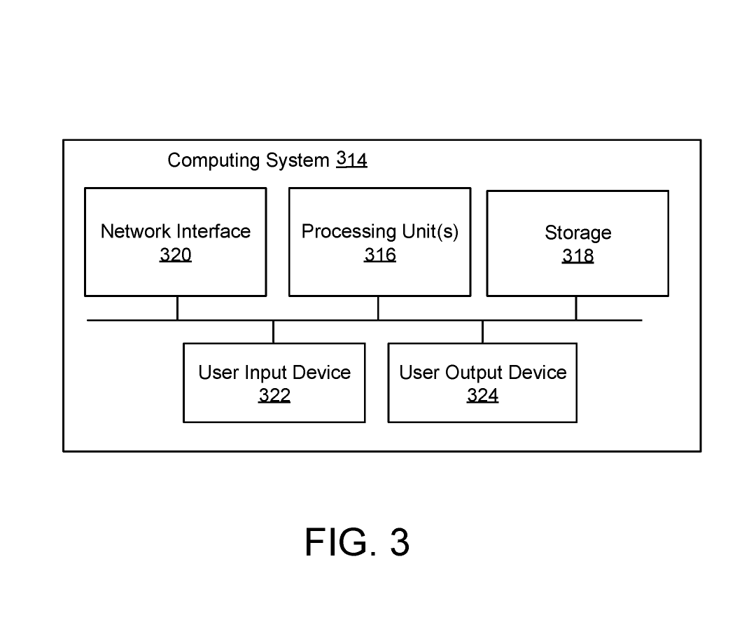

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that functions as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionalities for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

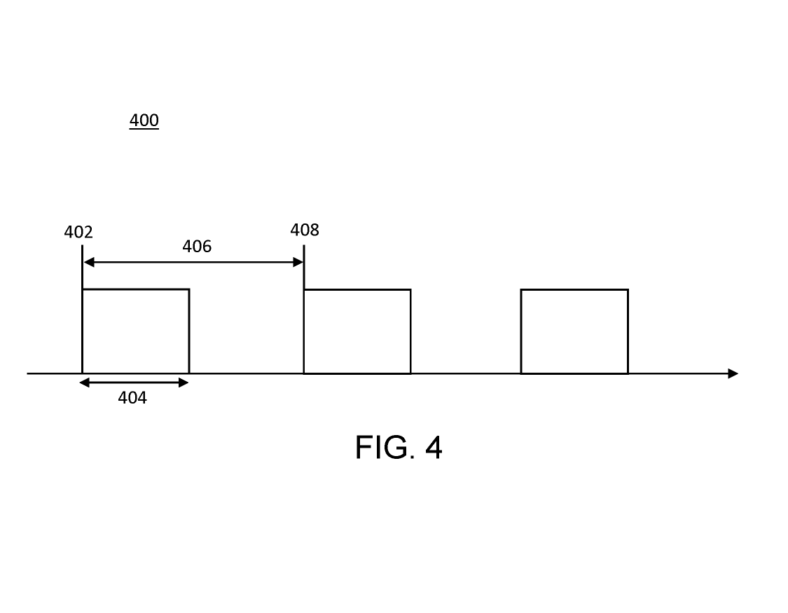

FIGS. 1-2 illustrate devices that communicate traffic streams, some of which may be latency sensitive (e.g., those carrying periodic AR/VR information/content). As described herein, the periodic operation of TWT benefits communication of periodic traffic (e.g., latency sensitive traffic) by predictably communicating the periodic traffic. FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406.

A TWT schedule may be communicated and/or negotiated using broadcast TWT (B-TWT) and/or individual TWT (I-TWT) signaling. In some embodiments, to signal I-TWT, TWT schedule information may be communicated to particular (individual) devices using a mode such as a Network Allocation Vector (NAV) to protect the medium access of TWT SPs. In contrast, to signal B-TWT, in some embodiments, a device (such as AP 105) may schedule TWT SPs with other devices (e.g., computing devices 110 and/or HWDs 150) and may share schedule information in beacon frames and/or probe response frames. Sharing schedule information using B-TWT may reduce overhead (e.g., negotiation overhead) as compared to the overhead used when sharing information using I-TWT.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

When P2P communication is established, various channel access rules may govern the P2P communication. An AP assisted P2P trigger frame sequence may reduce the contention/collision associated with TWT (or R-TWT) in P2P communication. Accordingly, a P2P model where a P2P STA (e.g., a HWD 150) is not associated with an infra-basic service set (BSS) AP, may improve P2P communication. Without AP’s assistance or coordination, a transmission over the P2P link may collide with another transmission in the BSS. In some embodiments, a reverse direction protocol (RDP) may be enabled for P2P communication. During RDP, when a transmitting STA has obtained a transmit opportunity (TXOP), the transmitting STA may grant permission for the receiving STA to transmit information back to the transmitting STA during the same TXOP. Accordingly, if a TWT setup allows P2P transmission and indicates RDP, the P2P communication can be performed after a triggered frame sequence (e.g., a reverse direction frame exchange). In other embodiments, other protocols may be enabled for P2P communication. In some embodiments, trigger-enabled TWT can reduce the medium contention and/or collisions between UL and DL transmissions. The trigger-enabled TWT may be indicated using a TWT information element (IE).

In some aspects, modern Wi Fi systems increasingly operate in environments where coexistence ( also referred to as “coex”) with narrowband wireless technologies (e.g., narrowband devices), including Bluetooth devices/links, narrowband peer to peer Wi Fi devices/links, and cellular devices/links, is unavoidable. Such coexistence is particularly critical for wearable devices and mixed reality platforms, in which multiple radios may operate concurrently within the same device or in close proximity to other narrowband transmitters. As Bluetooth technologies expand operation into the 5 GHz and/or 6 GHz bands, coexistence challenges for Wi Fi become more pronounced. Narrowband technologies (or devices) typically occupy only a limited portion of the Wi Fi operating bandwidth and often transmit with short, intermittent duty cycles. Despite this limited spectral footprint, narrowband transmissions can substantially impair Wi Fi operation by either triggering clear channel assessment across a wide channel or transmitting without performing clear channel assessment, resulting in collisions with Wi Fi frames. A narrowband device may refer to a wireless device or radio technology that operates over a bandwidth that is smaller than the operating bandwidth of a coexisting Wi Fi system and that may occupy only a subset of Wi Fi subchannels or subcarriers. Such a narrowband device may include, for example, Bluetooth devices/links, narrowband peer to peer Wi Fi devices/links, cellular devices/links, or other short duty cycle wireless technologies that transmit intermittently and may or may not perform clear channel assessment prior to transmission.

In some aspects, Wi Fi systems may introduce mechanisms that allow a station to signal periods of unavailability that may be used to represent coexistence activity. However, such signaling may represent “hard” or “complete” unavailability and apply uniformly across the entire operating bandwidth. In practical coexistence scenarios observed in existing devices, and in anticipated future deployments, coexistence activity frequently affects only a subset of subchannels within a wide Wi Fi channel. Such mechanisms of “hard” or “complete” unavailability do not provide a means to indicate reduced availability or coexistence activity on a partial bandwidth basis, nor do they distinguish between complete unavailability and probabilistic or intermittent coexistence conditions. As a result, such approaches of “hard” or “complete” unavailability lack the ability to efficiently convey coexistence activity limited to specific frequency regions, even though such granularity would enable continued use of unaffected portions of the spectrum.

In some aspects, treating coexistence activity as complete unavailability may introduce several adverse consequences for Wi Fi operation. Packet failures and retransmissions caused by narrowband interference increase end to end latency for delay sensitive traffic and lead to elevated power consumption due to prolonged device wake time and repeated transmission attempts. In addition, access points may misinterpret coexistence induced losses as degraded link quality, causing aggressive rate reduction or cessation of transmissions to affected stations, further exacerbating latency and power inefficiency. These effects are particularly problematic as Wi-Fi standards introduce efficiency features such as dynamic subchannel operation, non primary channel access, and enhanced OFDMA (Orthogonal Frequency Division Multiple Access), which are specifically designed to allow stations to operate on subsets of the available bandwidth. When coexistence activity is represented solely as complete unavailability, stations may be prevented from benefiting from these features, resulting in unnecessarily rigid behavior and reduced medium access efficiency in scenarios where only partial bandwidth coexistence is present.

In some aspects, in Narrowband (NB) and/or Bluetooth (BT), coexistence issues can be observed in devices in many use cases in which the coex activity may only be limited to a subset of subchannels of Wi-Fi operating bandwidth. For example, NB coex issues are important for future Wi-Fi networks as NB technologies including Bluetooth start using 5 and 6 GHz bands. In those coex cases, existing technologies and standards (e.g., Wi-Fi 7 or Wi-Fi 8) may use a hard unavailability or a complete unavailability for coex activity indication, which may span the entire operating bandwidth. This unavailability indication may lead to inefficiency and/or higher latency and higher power consumption for devices.

To address these problems, according to certain aspects, embodiments in the present disclosure relate to techniques for enabling the capability to indicate a coex activity and/or unavailability on a partial bandwidth. Some embodiments can provide the ability to not only indicate (1) complete unavailability due to a coex activity, but also to indicate (2) partial unavailability and/or reduced operation due to a coex activity, and/or (3) coex activity indication for partial bandwidths within Wi-Fi operating bandwidth. During periods of coexistence activity, a system or method in some embodiments may selectively omit affected frequency resources while continuing Wi Fi transmissions on remaining portions of the operating bandwidth.

In some embodiments, signaling and protocols can be defined to extend unavailability indication to cover the following use cases for devices: (1) coex activity indication for a subset of frequencies in the operating bandwidth, (2) a “soft” unavailability, where the device may have some probability of being unavailable during indicated time and/or indicated frequency resources, and/or (3) additional signaling to control AP behaviors during coex periods. e.g., initiating transmissions with initial control frames (like request to send (RTS)/ clear to send (CTS)), and not using trigger frames.

In some embodiments, a system or method can indicate a coex activity (e.g., Wi Fi/NB coex activity for partial bandwidths). The system can implement signaling and protocols for unavailability indication mechanisms which not only include indicating a hard or complete unavailability that applies to an entire Wi Fi operating bandwidth, but also allow a station to indicate coexistence activity with narrowband technologies during specified time periods and/or, when applicable, only on a subset of frequencies within the operating bandwidth. Coexistence activity, as used herein, refers to interference or concurrent operation from narrowband technologies that may affect the station’s ability to transmit or receive Wi Fi frames.

In some embodiments, the system or method can provide a soft unavailability indication, in which the station signals that it may have some probability of being unavailable during the indicated time and/or on the indicated frequency resources rather than being strictly unavailable. This soft unavailability may apply either to the entire operating bandwidth or to selected subchannels and may indicate reduced or uncertain availability due to coexistence activity rather than a prohibition on communication. The indication may convey that Wi Fi frame exchanges may be disrupted or intermittently impaired, while still permitting communications to proceed subject to coexistence aware constraints (e.g., particular time and/or particular frequency resources).

In some embodiments, the system or method can provide additional signaling that enables control of access point behavior during coexistence periods. Based on the indicated coexistence activity and/or soft unavailability, an access point may adjust its transmission procedures, including initiating transmissions using initial control frames such as RTS/CTS and avoiding trigger based transmissions during the indicated periods. Where the coexistence activity is limited to a subset of frequencies within the operating bandwidth, the access point may continue to schedule Wi Fi transmissions on remaining subchannels while avoiding affected frequencies. By enabling coexistence activity to be indicated with time and frequency granularity, the system or method can allow continued operation on unaffected portions of the operating bandwidth, thereby reducing interruptions, improving medium access efficiency, and avoiding unnecessary latency and power consumption.

In some embodiments, the system or method can operate in coexistence scenarios in which a narrowband device coexistence activity occupies only a portion of a Wi Fi operating bandwidth. For example, Bluetooth standards organizations and regulatory bodies are considering limiting Bluetooth activity to a subset of Wi Fi operating channels to promote improved coexistence behavior. Under such conditions, Bluetooth transmissions may be confined to 20 MHz or 40 MHz subchannels within a wider Wi Fi operating bandwidth, such as 80 MHz or 160 MHz. Consistent with these considerations, systems and methods in some embodiments may be implemented in products designed to restrict Bluetooth operation to selected subchannels, resulting in coexistence activity that is localized to particular frequency ranges rather than spanning the full Wi Fi channel.

In some embodiments, partial bandwidth coexistence may also arise in Wi Fi peer to peer operation. For example, a Wi Fi P2P link may be configured to operate using a narrower bandwidth, such as 20 MHz or 40 MHz, while an infrastructure Wi Fi link associated with the same device operates on a wider bandwidth. In such configurations, interference generated by the P2P connection may be periodic and limited to the specific subchannels corresponding to the narrower bandwidth, thereby creating coexistence activity that affects only a subset of frequencies within the operating bandwidth of the infrastructure link.

In some embodiments, a system or method can enable an infrastructure Wi Fi link to indicate coexistence activity with time and frequency granularity, such as at a time–frequency resource block level. During indicated periods of coexistence activity, the system or method may omit the affected frequencies or subcarriers from Wi Fi transmissions while continuing to use the remaining subcarriers within the operating bandwidth. This selective use of frequency resources can allow Wi Fi communications to proceed without interference from narrowband activity, thereby improving latency performance and reducing power consumption relative to approaches that treat partial bandwidth coexistence as complete unavailability.

In some embodiments, the system or method can provide periodic unavailability or coexistence activity signaling on subchannels within a Wi Fi operating bandwidth using a Channel Usage element included in Channel Usage Request and Channel Usage Response frames. When a Usage Mode subfield of the Channel Usage element is set to an unavailability mode value, such as Usage Mode 3, one or more Channel Entry fields may be present. Each Channel Entry field may include one or more Operating Class and Channel fields that identify frequency resources. The channels indicated by the Channel Entry field may correspond to a single contiguous frequency portion or to multiple non contiguous frequency bands defined by separate Operating Class and Channel fields, with all indicated channels being within the station’s operating bandwidth.

In some embodiments, the Usage Mode may be set to a new value referred to as a “coex activity” mode (or “soft unavailability” mode), with a TWT element present and the Channel Entry field optionally present. The presence of the TWT element may specify the time parameters associated with the coexistence activity or soft unavailability, while the optional Channel Entry field may specify whether the indication applies to the entire operating bandwidth or only to selected channels. When the Channel Entry field is absent, the coexistence activity or soft unavailability may apply across the full operating bandwidth during the indicated times. When the Channel Entry field is present, the coexistence activity or soft unavailability may apply only to the identified channels. In either case, the station may be intermittently unavailable, or available with coexistence activity that may affect its ability to transmit or receive wireless frames during the indicated times and frequencies.

In some embodiments, if a Channel Usage Request frame includes both a TWT element and a Channel Entry subfield, the station’s request for unavailability or coexistence activity may apply only to the channels indicated in the Channel Entry subfield. Correspondingly, if a Channel Usage Response frame includes both a TWT element and a Channel Entry subfield, the access point’s response may apply only to the indicated channels. In some embodiments, when the access point sends a Channel Usage Response frame with an “ACCEPT” indication using an unavailability usage mode (e.g., set in Usage Mode subfield of the Channel Usage element) and both the TWT element and Channel Entry subfield are present, the access point shall not send to or solicit any PPDUs (Physical Layer Protocol Data Unit) from the station at the indicated times that cover the frequencies or subcarriers identified in the Channel Entry subfield, while still being permitted to transmit PPDUs that assign partial bandwidth to the station and exclude those frequencies or subcarriers identified in the Channel Entry subfield, such as by using dynamic subchannel operation, non primary channel access, or OFDMA.

In some embodiments, when the access point sends a Channel Usage Response frame with an “ACCEPT” indication using the coex activity mode or the soft unavailability mode (e.g., set in Usage Mode subfield of the Channel Usage element) and the TWT element is present but the Channel Entry subfield is absent, the access point may send to or solicit PPDUs from the station during the indicated times only if such transmissions are preceded by initial control frames such as RTS or MU (Multi-User) RTS frames, and the access point may refrain from sending Basic Trigger frames allocating resources to the station during the coexistence period. When both the TWT element and the Channel Entry subfield are present with the coex activity mode or the soft unavailability mode, the access point may send to or solicit PPDUs during the indicated times provided that the transmissions do not cover the frequencies or subcarriers identified in the Channel Entry subfield. If such PPDUs are preceded by an initial control frame (sent by the access point) other than a Basic Trigger frame, the indicated frequencies may be included.

In some embodiments, the system or method can extend dynamic unavailability operation defined in standards (e.g., Wi Fi 8) by enabling coexistence or unavailability signaling that is based on both time and frequency, rather than time alone. The system or method may extend the dynamic unavailability operation by including a subchannel level frequency indication within a Multi STA Block Ack frame, thereby allowing a station to identify specific portions of the operating bandwidth affected by unavailability (e.g., “complete” or “soft” unavailability) or coexistence activity during an indicated time interval.

In some embodiments, the system or method may include an eight bit Subchannel Bitmap subfield within the Block Ack Bitmap subfield of a Per AID TID Info field in the Multi STA Block Ack frame for dynamic unavailability operations. For example, each bit of the Subchannel Bitmap may correspond to a 20 MHz subchannel of the basic service set bandwidth, or equivalently to a corresponding 242 tone resource unit, starting from the lowest frequency of the operating channel. Each Subchannel Bitmap represents up to 160 MHz of spectrum, and all frequencies indicated by the bitmap are within the operating bandwidth of the station. A two bit Subchannel Bitmap Position field indicates the relative position of the bitmap within the overall frequency band and is set to a default value (e.g., “00”) when the operating bandwidth does not exceed 160 MHz.

In some embodiments, when the operating bandwidth is greater than 160 MHz, the station may include multiple Per AID TID Info fields, each carrying a Subchannel Bitmap and an associated Subchannel Bitmap Position value that identifies the bitmap’s relative position within the broader frequency map. In some embodiments, to indicate that the operating bandwidth is greater than 160MHz, the station may include multiple Per AID TID Info fields (e.g., two for 320 MHz, four for 640 MHz), each carrying a Subchannel Bitmap with a relative position in the frequency map indicated by the Subchannel Bitmap Position field. For example, to indicate subchannels of 320 MHz operating bandwidth, STA may include two Subchannel Bitmaps (for corresponding two Per AID TID Info fields), with the two Subchannel Bitmap Position fields set to “00” and “01”, respectively. To indicate subchannels of 640 MHz operating bandwidth, STA may include four Subchannel Bitmaps (for corresponding four Per AID TID Info fields), with the four Subchannel Bitmap Position fields set to “00”, “01”, “10”, and “11”, respectively. When multiple Block Ack Bitmap fields are present, the Unavailability Target Start Time and Unavailability Duration fields may be identical across all such fields, ensuring a common timing reference for the indicated frequency regions.

In some embodiments, when a Block Ack Bitmap includes a Subchannel Bitmap with at least one bit set, the dynamic unavailability operation may apply only to the subchannels identified by the Subchannel Bitmap and Subchannel Bitmap Position fields, rather than to the entire operating bandwidth. The station may further include an indication of coexistence activity (or soft unavailability), for example by using “reserved” bits in the Starting Sequence Number or “reserved” bits in Block Ack Bitmap fields. When such an indication is present, the Unavailability Target Start Time and Unavailability Duration fields are interpreted as defining periods of coexistence activity or soft availability rather than complete unavailability, indicating that the station may be intermittently unavailable or subject to coexistence interference on the identified subchannels during the indicated time period.

Embodiments in the present disclosure have at least the following advantages and benefits. First, e mbodiments in the present disclosure can introduce soft unavailability to represent probabilistic or intermittent impairment due to coexistence activity rather than strict or complete unavailability. By distinguishing between complete unavailability and coexistence conditions in which transmissions may still succeed, the signaling in some embodiments can prevent access points from misclassifying coexistence induced packet losses as degraded link quality. This can reduce unnecessary rate reduction, station de prioritization, or suspension of transmissions, and enables coexistence aware transmission behavior that is better aligned with actual channel conditions. As a result, latency sensitive traffic experiences fewer disruptions, and stations avoid prolonged wake times and excessive retransmissions that would otherwise increase power consumption.

Second, e mbodiments in the present disclosure can enable substantially improved spectrum utilization in coexistence environments by allowing unavailability or coexistence activity to be indicated with both time and frequency granularity. By supporting coexistence indications that are limited to a subset of frequencies within the operating bandwidth, access points are able to continue scheduling transmissions on unaffected subchannels rather than treating the station as completely unavailable. This partial bandwidth awareness allows infrastructure Wi Fi links to avoid narrowband interference while maintaining data flow, thereby increasing medium access efficiency and improving overall system throughput in scenarios where coexistence activity affects only localized frequency resources.

Third, e mbodiments in the present disclosure can apply to Wi Fi deployments in which narrowband technologies, including Bluetooth, increasingly operate in the 5 GHz and 6 GHz bands, for example. By conveying coexistence indications that convey a schedule or upcoming periods of coexistence activity from a station to an access point, e mbodiments in the present disclosure can allow the access point to anticipate when the station may be unable or impaired in transmitting or receiving Wi Fi frames due to narrowband operation. This advance awareness enables coexistence aware scheduling decisions that reduce failed transmissions and unnecessary retransmissions, thereby improving reliability, latency, and overall efficiency of Wi Fi communications in environments with growing narrowband coexistence.

With the foregoing in mind, the figures and description below illustrate various non-limiting example embodiments of indicating soft unavailability and/or coexistence activities during indicated time and/or with respect to indicated frequency resources . Other implementations and configurations may also be used in accordance with the present disclosure.

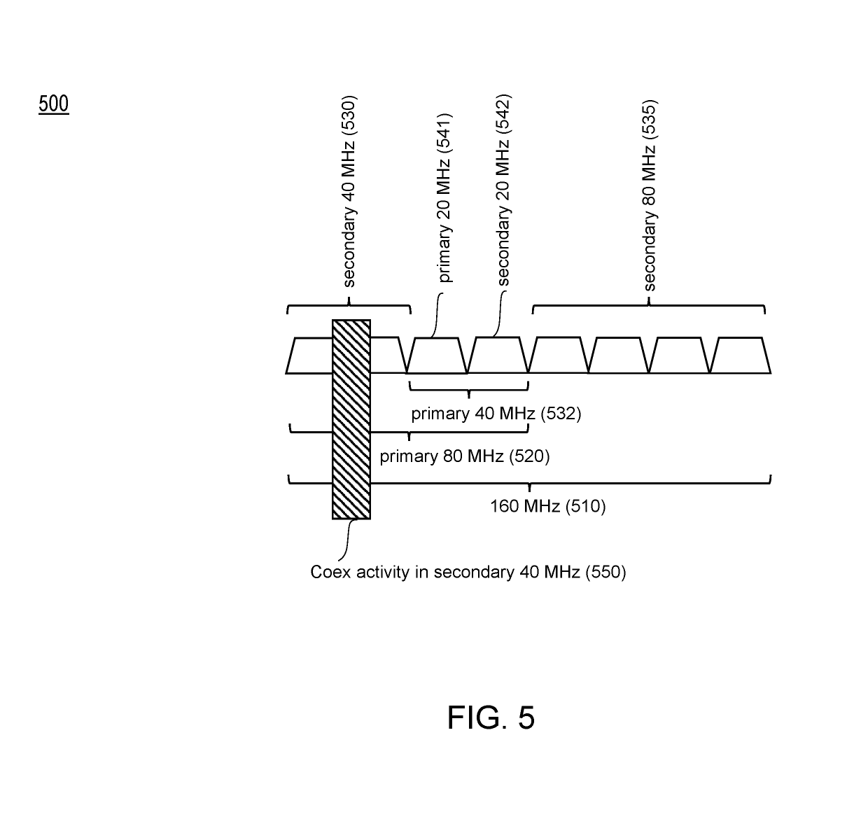

FIG. 5 is a diagram 500 showing an example coexistence activity in an operating bandwidth, according to an example implementation of the present disclosure. FIG. 5 illustrates a representative operating scenario in which a Wi Fi operating bandwidth 510 of 160 MHz is divided into multiple hierarchical sub bands, including a primary 80 MHz bandwidth 520 and a secondary 80 MHz bandwidth 535. Within the primary 80 MHz bandwidth 520, a primary 40 MHz bandwidth 532 and a secondary 40 MHz bandwidth 530 are defined, and within the primary 40 MHz bandwidth 532 there is a primary 20 MHz subchannel 541 and a secondary 20 MHz subchannel 542.

In the illustrated scenario, coexistence activity 550 occurs within one of the secondary 40 MHz subchannels 530 of the operating bandwidth 510. Such coexistence activity may correspond to narrowband operation, such as Bluetooth or other narrowband wireless technologies, that interferes with Wi Fi transmissions only within the affected sub band. During periods of coexistence activity, a system or method in some embodiments may selectively omit affected frequency resources while continuing Wi Fi transmissions on remaining portions of the operating bandwidth.

In some embodiments, based on the indicated coexistence activity, the system or method may omit the affected frequencies or subcarriers associated with the coexistence activity 550 while continuing Wi Fi transmissions using the remaining subcarriers within the operating bandwidth 510, including those within the primary 80 MHz bandwidth 520, the primary 40 MHz bandwidth 532, the primary 20 MHz subchannel 541, and other unaffected portions of the spectrum. By excluding only the frequencies impacted by coexistence activity and maintaining transmissions on the remaining frequency resources, systems and methods according to some embodiments can enable continued data communication without interference, reduce transmission failures and retransmissions, improve latency performance, and lower power consumption relative to approaches that suspend Wi Fi operation across the full operating bandwidth.

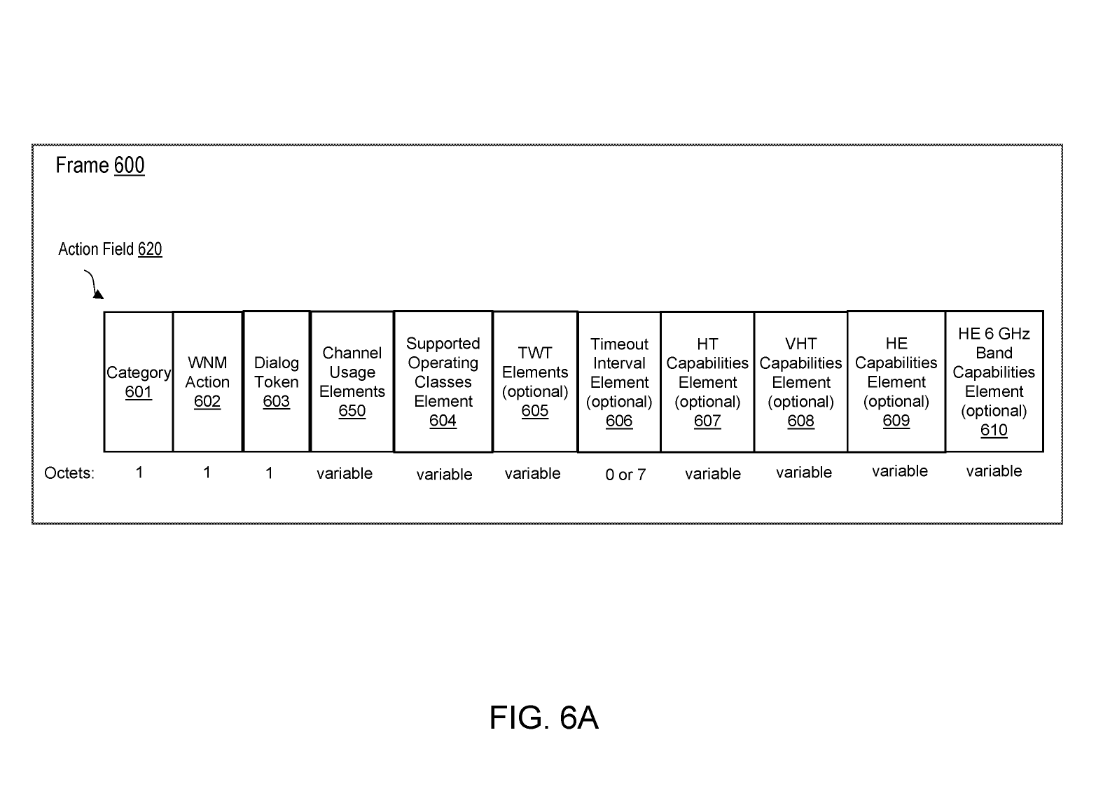

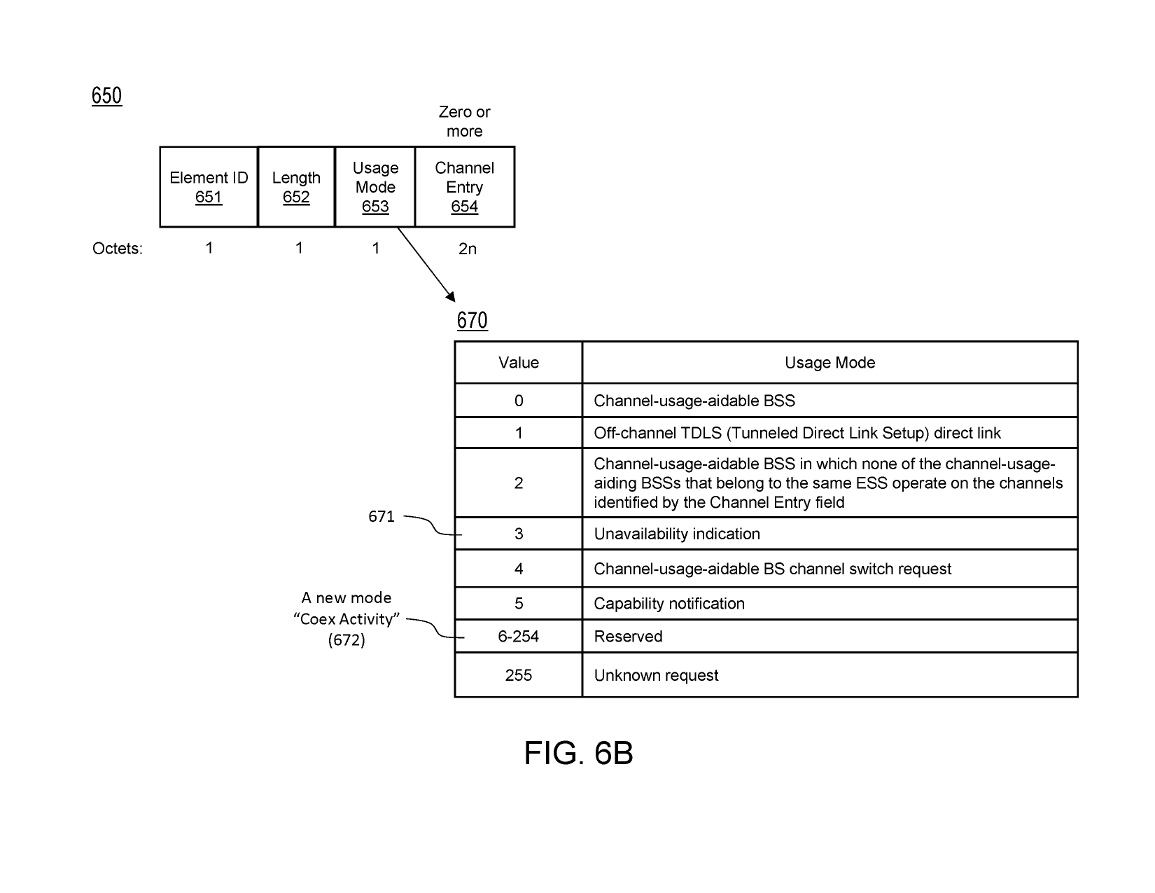

FIG. 6A and FIG. 6B illustrate example field formats for indicating soft unavailability and/or coexistence activities during indicated time and/or with respect to indicated frequency resources , according to an example implementation of the present disclosure. The communication signaling illustrated in FIGS. 6A and 6B relates to unavailability and coexistence activity indication in a wireless system, such as an IEEE 802.11 system, for non access point stations (non AP STAs). FIG. 6A shows a Channel Usage Request frame Action field format 620 which may be included in a frame 600. The frame 600 may be a Channel Usage Request frame or a Channel Usage Response frame. The Action field format 620 may include a Category field 601, a WNM (Wireless Network Management) Action field 602, a Dialog Token field 603, and a Channel Usage element 650, a Supported Operating Classes element 604, one or more optional Target Wake Time (TWT) elements 605 (optional), a Timeout Interval element 606 (optional), and a plurality of optional elements. The optional capability elements may include HT Capabilities 607, VHT Capabilities 608, HE Capabilities 609, and HE 6 GHz Band Capabilities 610. As shown in FIG. 6B, the Channel Usage element 650 may include an Element ID 651, a Length field 652, a Usage Mode field 653, and a Channel Entry field 654 that may be present zero or more times.

In some embodiments, the Usage Mode field 653 may be set to a value 671, for example, “3”, as shown in the Usage Mode table 670 of FIG. 6B, to indicate an unavailability condition (e.g., “strict” or “complete” unavailability) for the STA. In some embodiments, when the Usage Mode is set to the unavailability indication value (e.g., 3), the Channel Entry field 654 is not present, and the indicated unavailability may be to the entire operating bandwidth of the STA. In this state, the TWT element 605 carried in the frame 600 may specify timing parameters for the unavailability, including a start time, a duration, and optionally a periodic schedule. The STA may therefore indicate either a one time unavailability interval or a recurring schedule of periodic unavailability (e.g., a periodic unavailability operation (PUO) mode configured using the TWT element 605), which may be used by the access point for coexistence based inactivity handling.

In some embodiments, the Usage Mode field 653 may be set to a value 672, for example, a value among the reserved values 6 to 254, as shown in the Usage Mode table 670 of FIG. 6B, to indicate a “Coex Activity” mode and/or “soft” unavailability for the STA.

In some embodiments, systems and methods can allow the Channel Usage element 650, when included in the frame 600 (e.g., a Channel Usage Request frame or a Channel Usage Response frame), to include one or more Channel Entry fields 654 even when the Usage Mode field 653 is set to the unavailability mode 671 or to the newly defined “Coex Activity” mode 672 identified in FIG. 6B. Each Channel Entry field 654 may include one or more Operating Class and Channel fields that identify frequency resources. The channels indicated by the Channel Entry field 654 may correspond to a single contiguous portion of frequencies or to multiple non contiguous frequency bands, and all indicated channels may be within the operating bandwidth of the STA. When a Channel Entry field 654 and a TWT element 605 are present in the Action field format 620 of the Channel Usage Request frame 600, the STA’s request for unavailability or coexistence activity may apply only to the channels identified by the Channel Entry field 654. When these fields are present in the Action field format 620 of the Channel Usage Response frame 600, the access point response may apply only to the indicated channels.

In some embodiments, when the access point sends a Channel Usage Response frame 600 with an “ACCEPT” indication and the Usage Mode field 653 set to the unavailability value/mode 671, and both the TWT element 605 and Channel Entry field 654 are present, the access point may refrain from sending to or soliciting physical layer protocol data units (PPDUs) that occupy the frequencies or subcarriers identified by the Channel Entry field during the indicated times. The access point may nevertheless transmit frames that assign only partial bandwidth to the STA, such as by using dynamic subchannel operation, non primary channel access, or orthogonal frequency division multiple access, provided that the excluded frequencies are not used.

In some embodiments, when the Usage Mode field 653 is instead set to the Coex Activity mode 672, the Channel Usage element 650 can convey that the STA may still be available during the times identified by the TWT element 605, but may experience coexistence activity that affects its ability to transmit or receive frames. If the TWT element 605 is present and the Channel Entry field 654 is absent, the access point may transmit to or solicit transmissions from the STA during the indicated times only when such transmissions are preceded by initial control frames, such as RTS (request to send) or MU-RTS (multi user request to send) frames, and/or in some embodiments, the access point may avoid sending trigger frames (e.g., Basic Trigger frames) allocating resources to the STA during those times. If both the TWT element 605 and Channel Entry field 654 are present with the Coex Activity mode 672, the access point may transmit or solicit transmissions during the indicated times provided that the transmissions do not occupy the frequencies or subcarriers identified by the Channel Entry field, although such frequencies may be included if the transmissions are preceded by an initial control frame (e.g., RTS or MU-RTS) other than a Basic Trigger frame.

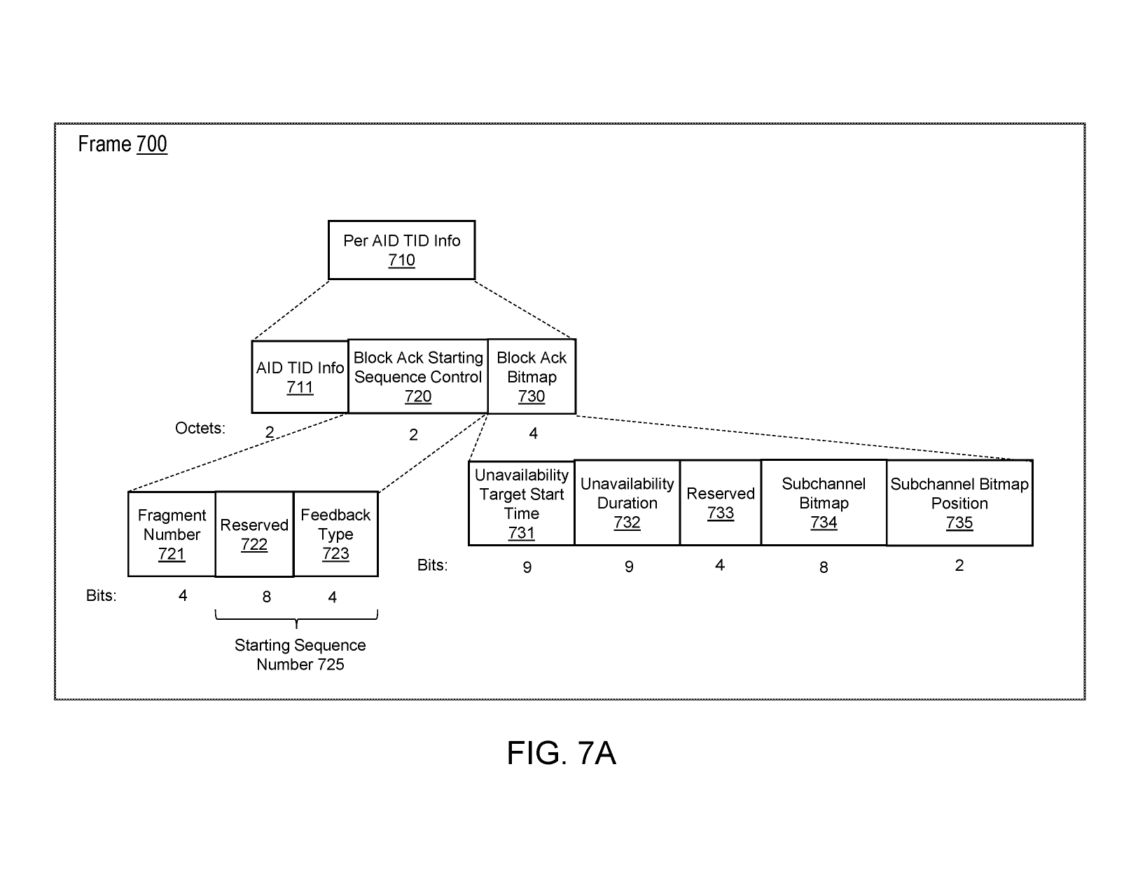

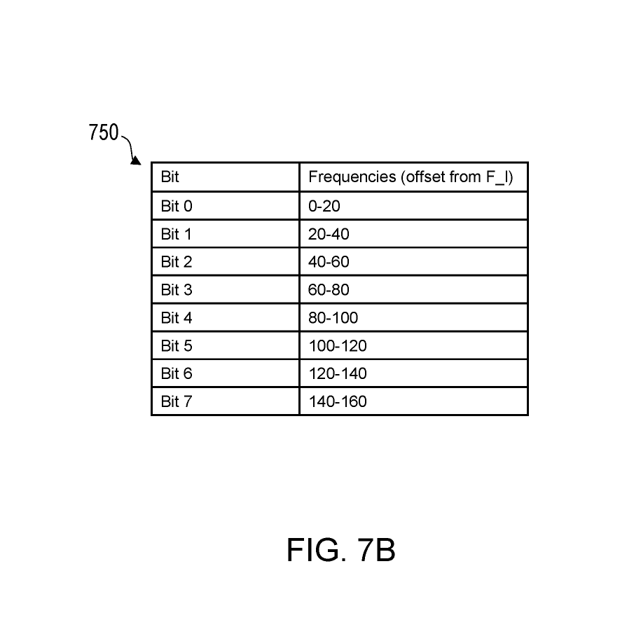

FIG. 7 A illustrates example field formats for indicating soft unavailability and/or coexistence activities during indicated time and/or with respect to indicated frequency resources , according to an example implementation of the present disclosure. The communication behavior illustrated in FIG. 7 A relates to a dynamic unavailability operation (DUO) mode that enables a non access point station (STA) to signal short term unavailability or coexistence activity within a transmit opportunity (TXOP). In this mode, an access point (AP) may initiate a TXOP by transmitting an initial control frame, such as a Trigger frame, and the STA may respond during the TXOP using a Multi STA Block Acknowledgement (BA) frame 700 that conveys whether the STA has an upcoming period of unavailability or coexistence activity that may affect frame exchanges during that TXOP. FIG. 7 A depicts an example Multi STA BA frame structure 700 that supports such dynamic signaling.

As shown in FIG. 7A, the Multi STA BA frame 700 may include one or more Per AID TID Info fields 710, each of which may correspond to a particular STA and traffic identifier. Each Per AID TID Info field may include an AID TID Info subfield 711, a Block Ack Starting Sequence Control field 720, and a Block Ack Bitmap field 730. The Block Ack Bitmap field 730 may include timing parameters, namely an Unavailability Target Start Time field 731 and an Unavailability Duration field 732, which together can define the start time and length of a period during which unavailability or coexistence activity is expected. The Block Ack Bitmap field 730 may further incorporate reserved bits 733, and a Subchannel Bitmap field 734 and a Subchannel Bitmap Position field 735 that together can convey frequency domain information associated with the unavailability or coexistence activity. The Block Ack Starting Sequence Control field 720 may include a Fragment Number field 721 and/or a Starting Sequence Number field 725 which may include reserved bits 722 and a Feedback Type field 723.

In some embodiments, the Subchannel Bitmap field 734 may include eight bits, with each bit corresponding to a 20 MHz subchannel of the basic service set bandwidth, or equivalently to a 242 tone resource unit, starting from the lowest frequency of the operating channel. For example, Table 750 in FIG. 7B shows that each of bits 0-7 represents a corresponding 20 MHz subchannel of the basic service set bandwidth (e.g., 160 MHz). Each Subchannel Bitmap (e.g., Subchannel Bitmap 734) can represent up to 160 MHz of spectrum, and all frequencies indicated by the bitmap may be within the operating bandwidth of the station. The Subchannel Bitmap Position field 735 may be a two bit Subchannel Bitmap Position field indicating the relative position of the bitmap within the overall frequency band. The Subchannel Bitmap Position field may be set to a default value (e.g., “00”) when the operating bandwidth does not exceed 160 MHz.

In some embodiments, when the operating bandwidth is greater than 160 MHz, the station may include multiple Per AID TID Info fields, each of which can carry a Subchannel Bitmap and/or an associated Subchannel Bitmap Position value that identifies the bitmap’s relative position within the broader frequency map. In some embodiments, to indicate that the operating bandwidth is greater than 160MHz, the station may include multiple Per AID TID Info fields (e.g., two for 320 MHz, four for 640 MHz), each of which can carry a Subchannel Bitmap with a relative position in the frequency map indicated by the Subchannel Bitmap Position field. For example, to indicate subchannels of 320 MHz operating bandwidth, STA may include two Subchannel Bitmaps (for corresponding two Per AID TID Info fields), with the two Subchannel Bitmap Position fields set to “00” and “01”, respectively. To indicate subchannels of 640 MHz operating bandwidth, STA may include four Subchannel Bitmaps (for corresponding four Per AID TID Info fields), with the four Subchannel Bitmap Position fields set to “00”, “01”, “10”, and “11”, respectively.

In some embodiments, when a Block Ack Bitmap includes a Subchannel Bitmap 734 with at least one bit set, the dynamic unavailability operation may apply only to the subchannels identified by the Subchannel Bitmap field 734 and the Subchannel Bitmap Position field 735, rather than to the entire operating bandwidth. When multiple Block Ack Bitmap fields 730 are present to convey multiple Subchannel Bitmaps, the Unavailability Target Start Time field 731 and the Unavailability Duration field 732 are identical across the fields, such that the indicated time interval applies uniformly to all indicated frequency regions.

In some embodiments, the station may further include an indication of coexistence activity (or soft unavailability), for example by using “reserved” bits 722 in the Starting Sequence Number field 725 or the “reserved” bits 733 in Block Ack Bitmap field 730. In some embodiments, the Feedback Type field 723 may include an unavailability mode, and an additional coexistence activity mode may be supported to distinguish soft coexistence periods from complete dynamic unavailability within the TXOP. When such an indication of coexistence activity (or soft unavailability) is present, the Unavailability Target Start Time field 731 and the Unavailability Duration field 732 can be interpreted as defining periods of coexistence activity or soft availability rather than complete unavailability, indicating that the station may be intermittently unavailable or subject to coexistence interference on the identified subchannels during the indicated time period.

In some embodiments, the present disclosure defines time and frequency resources used for scheduling and medium access as resource units, also referred to as “RUs”. An RU may represent a combination of temporal and spectral resources over which wireless transmissions may occur. In the context of periodic unavailability operation (PUO), an RU may be identified in the time domain by parameters contained in a TWT element and in the frequency domain by information contained in a Channel Usage element. In the context of dynamic unavailability operation (DUO), an RU may be identified in the time domain by start time and duration fields conveyed in a block acknowledgment frame, and in the frequency domain by a subchannel bitmap that identifies affected frequency portions within the operating bandwidth.

In some embodiments, RUs that are subject to coexistence activity are referred to herein as affected RUs. In configurations in which a system or method operates using an unavailability mode for either PUO operation or DUO operation, transmissions may be prohibited on affected RUs during the indicated time intervals, while there may be no restriction on the use of unaffected RUs. As a result, wireless communications may continue on frequency and time resources that are not impacted by unavailability, without constraint.

In configurations in which a system or method operates using a coexistence activity mode (or soft unavailability mode) for PUO operation or DUO operation, there may be similarly no restriction on the use of unaffected RUs, while affected RUs may still be used subject to coexistence aware transmission constraints. In such embodiments, transmissions that include affected RUs may be initiated using an initial control frame, such as a RTS frame or a MU- RTS frame. During periods in which coexistence activity is indicated, an access point may refrain from allocating affected RUs using a trigger frame (e.g., Basic Trigger frame), and/or may refrain from using a trigger frame (e.g., Basic Trigger frame) altogether if the transmission time overlaps with the coexistence activity interval. If the access point performs transmissions that include affected RUs, transmission failures occurring on such transmissions, including failed MAC protocol data units, may not be used for rate control, link adaptation, or retransmission decisions applicable to transmissions that occur outside of the coexistence activity time period.

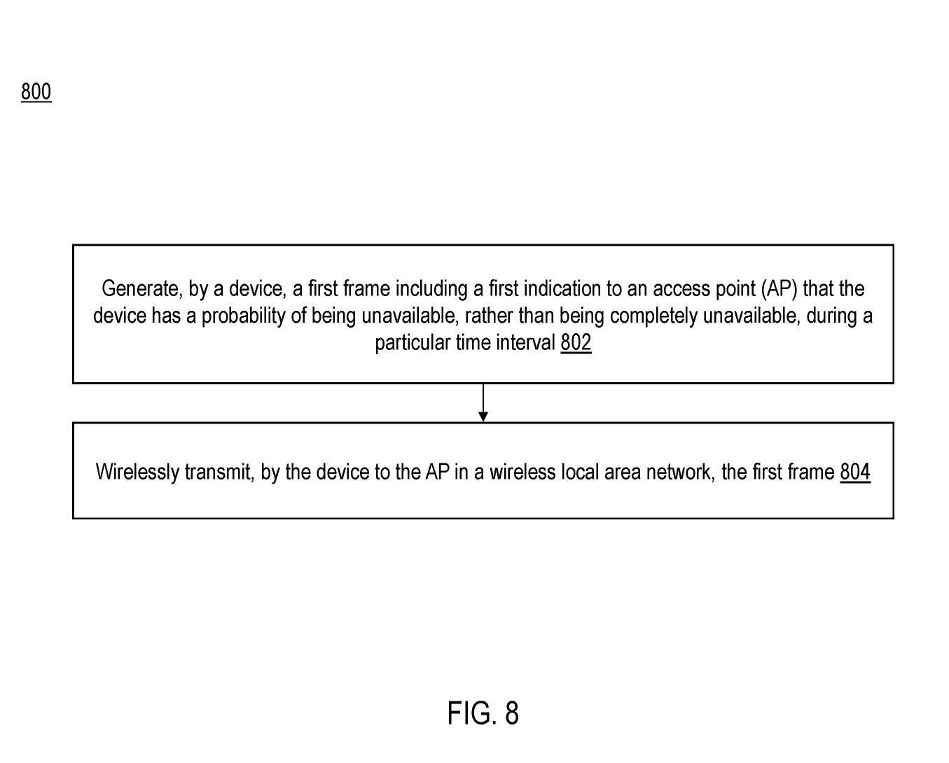

FIG. 8 is a flowchart showing a method for indicating soft unavailability and/or coexistence activities during indicated time and/or with respect to indicated frequency resources , according to an example implementation of the present disclosure. In some embodiments, the process 800 may be performed by a device (e.g., device or non-AP STA 110A, 110B, HWD 150A, 150B, computing system 314). In some embodiments, the process 800 is performed by other entities. In some embodiments, the process 800 includes more, fewer, or different steps than shown in FIG. 8.

In one approach, one or more processors (e.g., one or more processors 316 of device 110A) may generate 802 a first frame (e.g., frame 600, frame 700) including a first indication (e.g., Coex Activity mode 672, reserved bits 722, reserved bits 733, Feedback Type field 723) to an access point (AP; e.g., AP 105) that the device has a probability of being unavailable, rather than being completely unavailable, during a particular time interval (e.g., time interval set using TWT elements 605, Unavailability Target Start Time 731, or Unavailability Duration 732).

In some embodiments, the first indication may indicate to the AP that the STA is co-existent with one or more narrowband devices during the particular time interval (e.g., Coex Activity mode 672). In some embodiments, the first frame may include a second indication (e.g., channel information set in Channel Entry field 654, subchannel information set in Subchannel Bitmap field 734) to the AP that the STA has a probability of being unavailable on a subset of channels or subcarriers in an operating bandwidth.

In some embodiments, the one or more processors may be configured to determine that the STA has the probability of being unavailable, rather than being completely unavailable. The one or more processors may be configured to set a first field (e.g., Usage Mode 653) to a first value (e.g., value 672) that corresponds to the first indication and is different from a second value (e.g., value 671) corresponding to an indication that the STA is completely unavailable.

In some embodiments, the first field may be a usage mode subfield (e.g., Usage Mode 653) of a channel usage information element (IE), e.g., Channel Usage Elements 650. In some embodiments, the first frame may include timing information (e.g., timing information set using TWT elements 605, Unavailability Target Start Time 731, or Unavailability Duration 732) identifying a start time and a duration of the particular time interval.

In some embodiments, the one or more processors may be configured to periodically (e.g., a periodic unavailability operation (PUO) mode configured using the TWT element 605) transmit, via the transceiver to the AP, a second frame (e.g., frame 600) including a third indication to the AP that the STA has a probability of being unavailable, rather than being completely unavailable.

In some embodiments, the one or more processors may be configured to receive, from the AP, an initial control frame (e.g., Trigger frame). The first frame (e.g., frame 700) may be transmitted by the STA to the AP in response to the initial control frame (e.g., dynamic unavailability operation (DUO) mode).

In one approach, the one or more processors may wirelessly transmit 804, via a transceiver (e.g., network interface 320) to the AP in a wireless local area network, the first frame. In some embodiments, wirelessly transmitting the first frame may cause the AP to, in response to receiving the first frame, avoid adjusting a modulation and coding scheme (MCS), transmit rate, and/or retry limit for the STA during the particular time interval. In some embodiments, wirelessly transmitting the first frame may cause the AP to, in response to receiving the first frame, exchange one or more initial control frames (e.g., RTS/CTS) with the STA before transmitting a data transmission, during the particular time interval.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device comprising:
one or more processors configured to:
generate a first frame including a first indication to an access point (AP) that the device has a probability of being unavailable, rather than being completely unavailable, during a particular time interval; and
wirelessly transmit, via a transceiver to the AP in a wireless local area network, the first frame.

2. The device of claim 1, wherein
the first indication indicates to the AP that the device is co-existent with one or more devices during the particular time interval, and
the one or more devices comprise at least one of one or more Bluetooth devices, one or more peer-to-peer wireless devices, or one or more cellular devices.

3. The device of claim 1, wherein the first frame includes a second indication to the AP that the device has a probability of being unavailable on a subset of channels or subcarriers in an operating bandwidth.

4. The device of claim 1, wherein the one or more processors are configured to:
determine that the device has the probability of being unavailable, rather than being completely unavailable; and
set a first field to a first value that corresponds to the first indication and is different from a second value corresponding to an indication that the device is completely unavailable.

5. The device of claim 1, wherein the first field is a usage mode subfield of a channel usage information element (IE).

6. The device of claim 1, wherein
wirelessly transmitting the first frame causes the AP to, in response to receiving the first frame, avoid adjusting a modulation and coding scheme (MCS), transmit rate, or retry limit for the device during the particular time interval.

7. The device of claim 1, wherein
wirelessly transmitting the first frame causes the AP to, in response to receiving the first frame, exchange one or more initial control frames with the device before transmitting a data transmission, during the particular time interval.

8. The device of claim 1, wherein the first frame includes timing information identifying a start time and a duration of the particular time interval.

9. The device of claim 1, wherein the one or more processors are configured to:
periodically transmit, via the transceiver to the AP, a second frame including a third indication to the AP that the device has a probability of being unavailable, rather than being completely unavailable.

10. The device of claim 1, wherein the one or more processors are configured to:
receive, from the AP, an initial control frame,
wherein the first frame is transmitted by the device to the AP in response to the initial control frame.

11. A method comprising:
generating, by a device, a first frame including a first indication to an access point (AP) that the device has a probability of being unavailable, rather than being completely unavailable, during a particular time interval; and
wirelessly transmitting, by the device to the AP in a wireless local area network, the first frame.

12. The method of claim 11, wherein
the first indication indicates to the AP that the device is co-existent with one or more devices during the particular time interval, and
the one or more devices comprise at least one of one or more Bluetooth devices, one or more peer-to-peer wireless devices, or one or more cellular devices.

13. The method of claim 11, wherein the first frame includes a second indication to the AP that the device has a probability of being unavailable on a subset of channels or subcarriers in an operating bandwidth.

14. The method of claim 11, comprising:
determining, by the device, that the device has the probability of being unavailable, rather than being completely unavailable; and
setting a first field to a first value that corresponds to the first indication and is different from a second value corresponding to an indication that the device is completely unavailable.

15. The method of claim 11, wherein the first field is a usage mode subfield of a channel usage information element (IE).

16. The method of claim 11, further comprising:
causing the AP to, in response to receiving the first frame, avoid adjusting a modulation and coding scheme (MCS), transmit rate, or retry limit for the device during the particular time interval.

17. The method of claim 11, further comprising:
causing the AP to, in response to receiving the first frame, exchange one or more initial control frames with the device before transmitting a data transmission, during the particular time interval.

18. The method of claim 11, wherein the first frame includes timing information identifying a start time and a duration of the particular time interval.

19. The method of claim 11, further comprising:
periodically transmitting, by the device to the AP, a second frame including a third indication to the AP that the device has a probability of being unavailable, rather than being completely unavailable.

20. The method of claim 11, further comprising:
receiving, by the device from the AP, an initial control frame,
wherein the first frame is transmitted by the device to the AP in response to the initial control frame.
